(19) United States
(12) Patent Application Publication
(10) Pub. No.: US 2024/0234019 A1
(43) Pub. Date: Jul. 11, 2024

(54) LOW LOSS INDUCTOR

(71) Applicant: TDK Electronics AG, München (DE)

(72) Inventors: Felipe JEREZ GALDEANO, Thalfingen-Elchingen (DE); Thomas GIMPEL, Heidenheim an der Brenz (DE); Thomas LENZEN, Graz (AT); Anneliese DRESPLING, Heidenheim (DE); Reinhard NEUREITER, München (DE)

(21) Appl. No.: 18/563,043

(22) PCT Filed: Jun. 24, 2022
(86) PCT No.: PCT/EP2022/067405

§ 371 Date: Nov. 21, 2023

(30) Foreign Application Priority Data
Jun. 25, 2021 (DE) 10 2021 116 533.4

(51) Int. Cl. H01F 27/29; H01F 17/00; H02M 3/04

(52) U.S. Cl. CPC H01F 27/292; H01F 17/0006; H01F 2017/004; H02M 3/04

(57) ABSTRACT

An inductor with reduced losses is provided. The inductor comprises a first terminal, a second terminal and a conductor between the first terminal and the second terminal. The first terminal, the conductor and the second terminal establish a monolithic structure.

The present invention refers to the field of inductors, specifically to low loss inductors that can be utilized in DC-DC converters. Further, the present invention refers to manufacturing processes for creating such inductors.

Inductors establish physical embodiments of inductance elements. Thus, inductors are not only characterized by their inductance, but also by—generally unwanted—ohmic losses. Correspondingly, the efficiency of circuit components comprising inductors depends on losses caused by passive components such as inductors. Thus, what is wanted is an inductor with reduced ohmic losses.

Inductors can be manufactured utilizing different methods. It is possible to create inductors by using copper structures, such as copper wires, and bending the wires to obtain a winding. Further it is possible to create inductors utilizing thin-film technologies.

However, there is a need for inductors that allow an increased efficiency of corresponding electrical circuits where the inductor has reduced ohmic losses. Further, a corresponding inductor shall have a reliable and mechanically stable coil structure. Further, it is preferred that the inductor has a precisely defined inductance, e.g. obtained by strictly complying with small deviations from a preferred shape of the coil structure. Further, it is preferred that an inductor can be used as an SMT-type inductor (SMT=surface mount technology).

From publications U.S. Pat. Nos. 9,490,062 and 10,014,102 coil structures being derived from processes utilizing thin film technology are known. 3D printing, which also can be used to establish inductors, is known from WO 02/07918 A1, U.S. Pat. No. 6,117,612 A and WO 2019/092193 A1. From WO 98/24574 A1 or WO 01/81031 A1 fusion processes involving laser or electron beams for processing thermoplastic compounds containing metal particles are known.

However, it is a desire to have inductors with improved parameters compared to known inductors or inductors that can be manufactured with known processes.

To that end, an inductor according to independent claim 1 is provided. Dependent claims provide preferred embodiments, methods of manufacturing or uses of specific processes to manufacture inductors.

The inductor comprises a first terminal and a second terminal. Further, the inductor comprises a conductor between the first terminal and the second terminal. The first terminal, the conductor and the second terminal establish a monolithic structure.

In this inductor the first terminal and the second terminal can establish terminals that allow the inductor to be electrically connected to an external circuit environment. The conductor between the first terminal and the second terminal establishes the coil structure of the inductor. The fact that the first terminal, the conductor and the second terminal establish a monolithic structure differentiates the inductor from known inductors where segments of the coil structures are soldered or welded to one another. The provision of a monolithic structure essentially reduces ohmic losses, increases reliability, reduces porosity and allows corresponding electrical circuits with increased energy efficiency.

It is possible that the inductor is derived via an electro-chemical additive manufacturing process (ECAM).

ECAM methods allows the use of an in-situ control loop to adjust the deposition of material during a manufacturing process. ECAM is known from US 2021/0054516 A1 or US 2017/0145584 A1. By using ECAM to establish an inductor, it is possible to control in which area and direction the material to be used for the inductor can be grown inside a galvanic bath. To that end, it is possible to use a commonly used bottom cathode and independently usable anode segments arranged above the bottom cathode. The anode segments can be arranged in a matrix-like pattern with columns and rows and can be actuated independently from one another.

Such an ECAM process allows the creation of monolithic inductors with terminals and the conductor establishing a coil structure in between the terminals. Further, the use of an ECAM process allows a high accuracy of the corresponding conductor shape and a lack of deformation because a heat treatment after the creation of the inductors is not necessary. Further, a plurality of inductors can be established simultaneously. Thus, per inductor a shorter process time, compared to inductors derived from printing plus firing and sintering, is obtained. Thus, as also no intermediate drying process is necessary after printing, a more cost-efficient solution is provided.

A special advantage of the use of an ECAM process is the high flexibility of defining the shape of the coil structure. Specifically, it is possible to maximize a conductor per volume ratio. Also, a switch from one shape of coil structure to another shape of coil structure is possible in a short time because only the programming of the individually actuatable anode segments is necessary.

Correspondingly, it is possible that the inductor is free from welding or soldering points.

Also, it is possible that the inductor has an outer perimeter and a volume within the perimeter. The first terminal, the second terminal and the conductor establish a structure with a volume. Then, the volume of the structure of the conductor and the first and second terminal is 60% or lager or 80% or larger compared to the volume of the perimeter of the inductor. A preferred volume range is between 60% and 80%. Thus, the degree of filling can be increased. Thus, for a given inductance the corresponding inductor can be manufactured with smaller spatial dimensions and/or reduced weight.

Further, reduced weight and smaller spatial dimensions also reduce the amount of chemical materials that are needed to establish an inductor. Thus, costs can be further reduced.

It is possible that the outer perimeter has the shape of a cuboid or of a cube. Thus, a large degree of filling different inductors within an external circuit environment is also possible as the designer of an inductor obtains a plurality of new degrees of freedom in designing individual shapes of inductors. In fact, the degree of freedom in designing inductors is only limited by the resolution of the matrix containing the individually actuatable anode segments.

It is possible that the inductor is an SMT-type inductor. Thus, the inductor can easily be integrated in an external circuit environment, e.g. on a circuit board with contact structures on the surface of the circuit board dedicated to be connected to the first and second terminal, respectively.

Further, it is possible that the conductor comprises a main constituent material that is selected from copper, aluminum, silver, gold or another preferred material with a high conductivity. It is possible that the main constituent material has a purity equal to 90% or more, 95% or more, 98% or more or 99% or more.

The application of the material of the main constituent in a galvanic bath allows to simply obtain such high degrees of purity, substantially decreasing porosity and ohmic losses.

Especially due to the higher number of degrees of freedom in designing the inductors, it is possible that the conductor comprises a cross section being different from the cross section of a wound wire where a wound wire usually has the cross section of a disk.

Specifically, it is possible that the conductor comprises a cross section being selected from a square, a rectangular, a polygon shape, a circular shape, an oval shape and a combination of all of this shapes or another shape that allows a high degree of filling the perimeter volume of inductor without short-circuiting different coil windings.

Further, it is possible that a corresponding DC-DC converter comprises an inductor as described above.

The DC-DC converter can be a high frequency DC-DC converter where the inductor can be used with other inductors or semiconductor switching devices to establish the voltage conversion functionality.

A method of manufacturing an inductor as described above can comprise an ECAM process.

Specifically, it is possible that a plurality of inductors are created simultaneously.

Thus, an ECAM process can be used to manufacture one or more inductors.

It is possible that the conductor of the inductor has a rectangular coil with copper being the main constituent material of the conductor. Every turn of the coil can be characterized by the copper thickness essentially only limited by the resolution of the matrix configuration of the anode segments. Typical values for characteristic smallest possible design features are between 10 μm and 300 μm, determined by the resolution of the matrix configuration. The coil can have characteristic dimensions between 100 μm and 10 mm in length, width and height. A space or gap between the turns must be provided to prevent short-circuits. The size of the gap can be in the range between 10 μm and 100 μm, also determined by the resolution of the matrix configuration. It is possible that the coil structure is molded with a magnetic material to further enhance the parameter range of the desired inductance values and to further improve mechanical stability and to improve the connection between the terminals and a PCB. At the terminals further material such as silver, nickel or tin can be provided to enhance the mechanical and electrical connection to the PCB.

Working principles and central aspects of details of preferred embodiments are shown in the accompanying schematic figures.

In the figures:

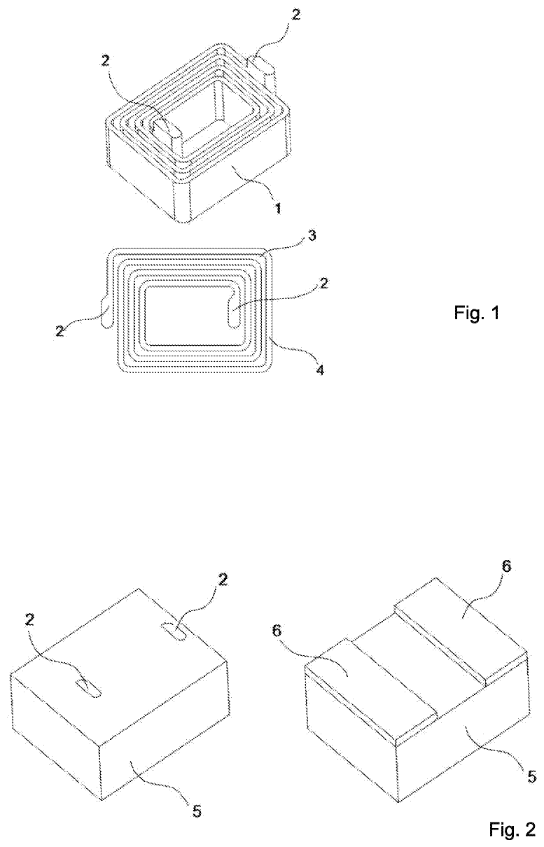

FIGS. 1 and 2 show perspective views of an inductor and a corresponding housing having an essentially cuboid-shaped perimeter area.

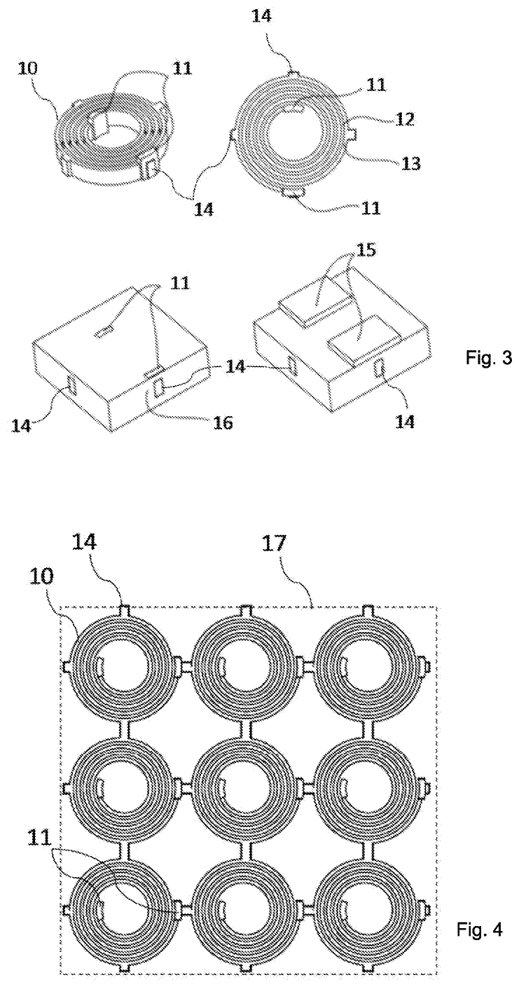

FIG. 3 shows perspective views of round inductors and corresponding cuboid shaped housings.

FIG. 4 shows a top view onto a plurality of inductors created together before singulation.

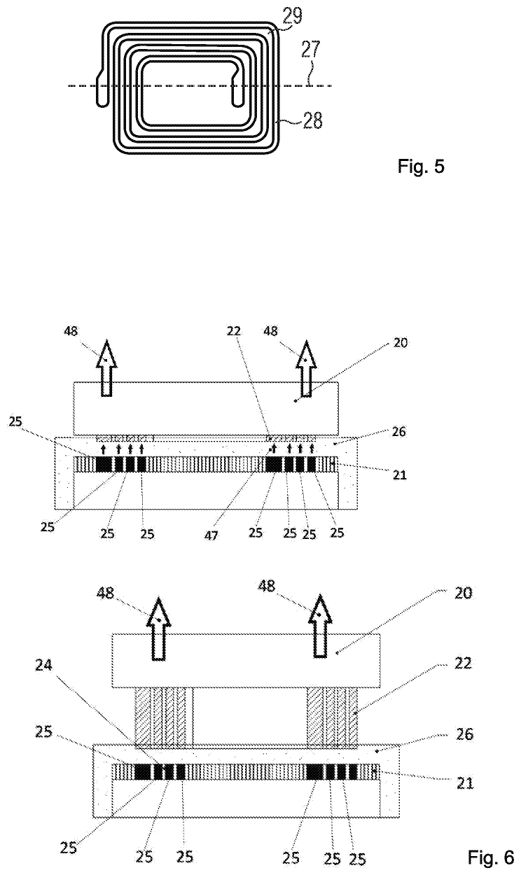

FIG. 5 shows a top view onto a specific inductor shape with increased thickness of the conductor at the terminals.

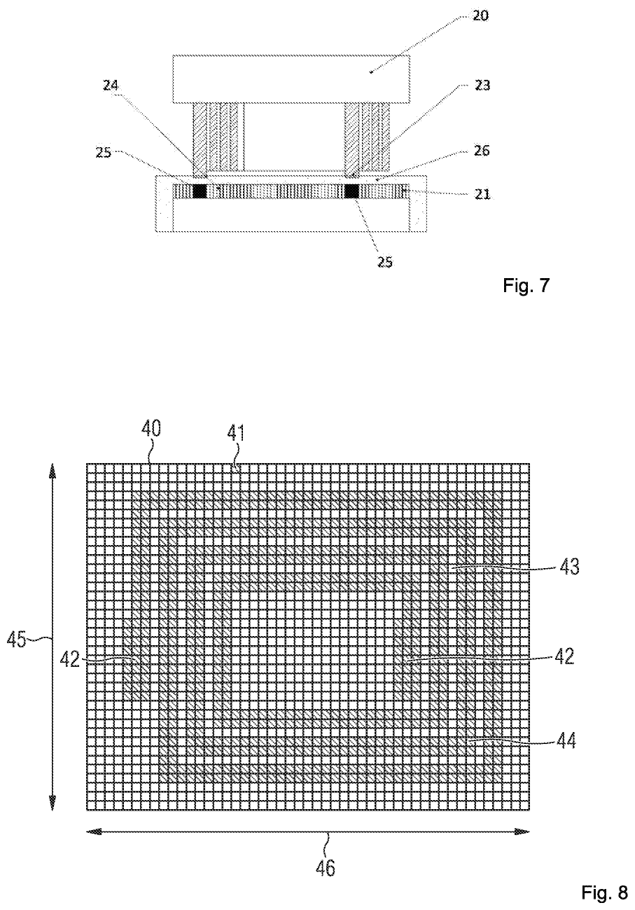

FIGS. 6 and 7 show different stages of manufacturing an inductor utilizing an ECAM process.

FIG. 8 shows the relation between activated and not activated matrix segments pixels).

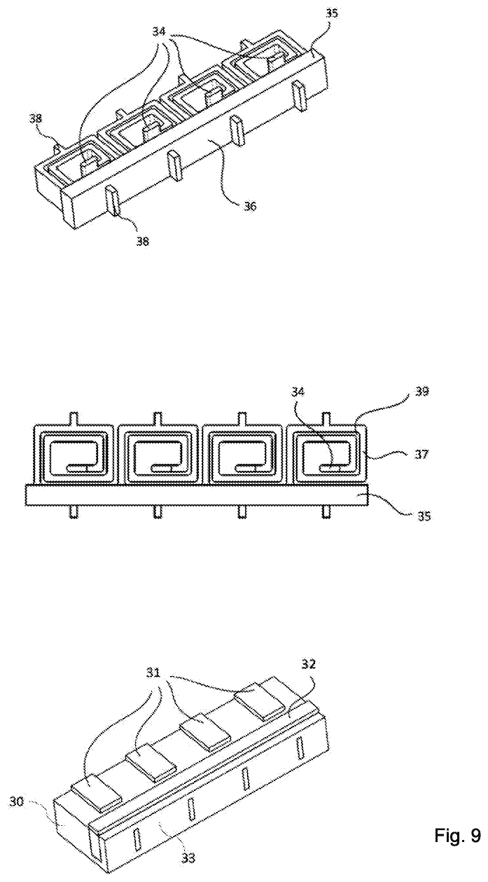

FIG. 9 shows perspective views (top and bottom portion) and a cross section view of a plurality of alternatively shaped conductors.

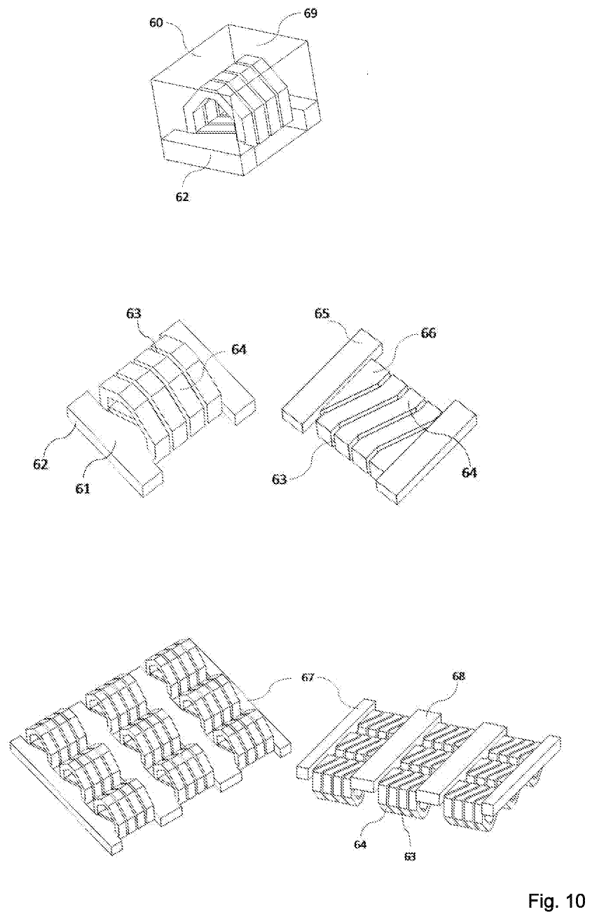

FIG. 10 shows perspective views of further possible shapes where a conductor winding has a polygon shape.

FIGS. 1 and 2 are a perspective view showing shapes of a rectangular coil (FIG. 1), e.g. with copper being the main constituent material and of a corresponding housing FIG. 2.

A winding of the conductor establishing the coil corresponds to a frame conforming to the different turns 1 and the terminals 2 establishing connection areas. Every turn of the coil 4 is characterized by the copper thickness; typical values for these characteristics are between 10 pm and 300 pm. The copper profile, i.e. the conductor, can have characteristically sized parameters (width, length, height) between 100 pm and 10 mm. The space or gap between turns 3 should prevent short circuits between the turns and, depending on the size of the parts, present values of the gap can be between 10 and 100 μm. The copper frame 1 could be molded with a magnetic material 5 to achieve the desired inductance of the created inductor. The mold material can also directly establish a housing of the inductor.

To improve the connection between the coil and a mounting location, e.g. a PCB, structured connection areas 6, e.g. with silver (and/or nickel and/or tin) can be printed or deposited at the housing at the location of the terminals 2.

FIGS. 3 and 4 provide alternative shapes showing the concept of a coil array 17 created in, but not limited to, a 3×3 configuration of coils 10 simultaneously printed, the array of coils is not limited in the number of units and can depend on the mechanical limitation of the manufacturing equipment. To give a good mechanical stability the coils 10 are joined at four points 14, every turn of the coil 13 is characterized by the copper thickness (e.g. between 10 μm and 300 μm) and the copper profile can have a size of 100 μm to 10 mm.

FIG. 5 shows the structure of the printed coil in a top view and process stages of the manufacturing are shown in FIGS. 6 and 7.

FIG. 6 shows the turns 28 of the top view of FIG. 5 in a side view as elements/copper depositions 25. Elements 25—later establishing the turns 28 of FIG. 5—are created by the active anode 25. The gap between the turns is created because there is no copper deposition due to inactive anode elements.

In FIG. 6 (top portion) we can see a preliminary stage for the process to create coils using a galvanic bath with a selective copper deposition process. Cathode 20 is moving along the Z axis 48 at a speed that allows the chemical reaction 47 (leading to the deposition) between the active anode and the cathode inside the galvanic bath 26.

At the beginning of the process, cathode 20 and the anodes 21 are quite close to allow to the copper structure to grow only in the area in which the corresponding anode segments 25 are active. Copper 24 does not grow in areas in which the anode is not active.

In the bottom portion of FIG. 6 a stage is shown where the cathode is already moved in the Z axis to allow more copper to grow in the active anode area.

In FIG. 7 some of the active anode segments are disconnected to allow the copper to grow only in the desired area to create some copper protrusions 23. Thus, a time-dependent selectivity of activity of different segments is possible to obtain a deviation from a translation symmetry in the vertical Z direction.

Further, in FIG. 8 a pitch 41 that could be energized or not is essentially defining the resolution of the obtainable copper figures. The pitch (and therefore the resolution) can be the same or different for different lateral directions.

Depending on the number of lateral dimensions 45, 46 a bigger or smaller copper structure could be produced.

FIG. 9 shows alternative shapes for a module of four coils 36. Every single coil has four independent contacts 34 and one common connection point 35, the complete module is molded with a magnetic material 33. The connection areas 34 and 35 are covered by termination pads 31 and 32, e.g. implemented with a silver (or nickel or tin) printed deposition. The modules could be also manufactured in an array, as shown in FIG. 4 with a common terminal 38.

FIG. 10 shows alternative shapes of produced coils 60. The copper structure 61 may be created in an array of coils, created but not limited to a 3×3 arrangement of coils. In this specific embodiment a coil is created in an axial construction instead of in a radial construction, the connection area with a PCB is created with a copper block 61. In order to achieve a low DC resistance the thickness of this copper block 62 will be increased to obtain the desired value. The gap between the different turns 63 could be covered by an insulation material. The coil could be implemented with a different number of turns 64. The copper block can be molded with a magnetic material 69 to achieve a desired inductance value.

To improve the manufacturability of the coils the product is created in a matrix 67 that could be molded as a block, to obtain the single inductors via a cutting or dicing process.

1. An inductor, comprising
a first terminal and a second terminal; and
a conductor between the first terminal and the second terminal, wherein
the first terminal, the conductor and the second terminal establish a monolithic structure.

2. The inductor according to claim 1, being derived via an Electro-Chemical Additive Manufacturing (ECAM) process.

3. The inductor according to claim 1, being free from welding or soldering points.

4. The inductor according to claim 1,
having an outer perimeter and a volume within the perimeter,
wherein
the first terminal, the second terminal and the conductor establish a structure with a volume and
the volume of the structure of the conductor and the first and second terminal is 60% to 80% or more of the volume of the perimeter of the inductor.

5. The inductor according to claim 4, wherein the outer perimeter has the shape of a cuboid or cube.

6. The inductor according to claim 1, being a SMT-type inductor.

7. The inductor according to claim 1, wherein the conductor comprises a main constituent material selected from copper, aluminum, silver, gold, wherein the main constituent material has a purity equal to 90% or more, 95% or more or 98% or 99% or more.

8. The inductor according to claim 1, wherein the conductor comprises a cross section being different from a disc.

9. The inductor according to claim 1, wherein the conductor comprises a cross section being selected from a square, a rectangle, a polygon, a circular, an oval shape and a combination of all of this shapes.

10. A DC-DC converter comprising an inductor of claim 1.

11. A method of manufacturing an inductor according to claim 1, comprising an ECAM process.

12. The method of claim 11, wherein a plurality of inductors is created simultaneously.

13. Use of an ECAM process to manufacture one or more inductors.

14. The inductor according to claim 2, wherein the ECAM process comprises the usage of a bottom cathode and independently usable anode segments, and wherein
the anode segments are arranged in a matrix-like pattern with columns and rows and can be actuated independently from one another.
